(19) United States
(12) Patent Application Publication
(10) Pub. No.: US 2008/0172881 A1
(43) Pub. Date: Jul. 24, 2008

(54) Rotary electric shaver and inner cutter therefor

(75) Inventor: Masaki Okabe, Matsumoto (JP)

Correspondence Address: Quinn Emanuel Urquhart Oliver & Hedges, LLP;Koda/Androlia, 10th Floor, 865 S. Figueroa Street, Los Angeles, CA, 90017, US

(73) Assignee: IZUMI PRODUCTS COMPANY

(21) Appl. No.: 12/004,376

(22) Filed: Dec. 20, 2007

(30) Foreign Application Priority Data
Dec. 22, 2006 (JP) 2006-345988

(51) Int. Cl. B26B 19/14; B26B 19/04

(52) U.S. Cl. 30/43.6; 30/346.51; 30/43.4

(57) ABSTRACT

An inner cutter including a circular hub unit, which is coupled to a rotary drive shaft, and a ring-shaped inner cutter main unit, which is secured to the hub unit and is formed with cutter blades standing up from their lower portions with the upper parts sliding against the inside lower surface of the outer cutter; and the cutter blades being formed with reduced cross-sectional portions that have a dimension in the radial direction of circular hub unit (or of the ring-shaped inner cutter main body) made smaller than a dimension in the radial direction of blade tip ends.

### BACKGROUND OF THE INVENTION

1. Field of the Invention

The present invention relates to a rotary electric shaver having a substantially disk-shaped outer cutter(s) which has numerous hair introduction openings in the upper surface, and an inner cutter(s), which is rotated while sliding against the inner surface of the outer cutter(s), and further relates to an inner cutter used in this electric shaver.

2. Description of the Related Art

One type of widely known rotary electric shaver includes an outer cutter(s), which is substantially disk-shaped and in which a ring shaped track (channel) is formed in the inner surface thereof and numerous hair introduction openings (slits, for example) are formed so as to cut across the track and to open to the upper surface of the outer cutter, and an inner cutter(s), which is provided so that it is rotated while the blades (cutter blades) thereof sliding against the track of the outer cutter, as disclosed in, for instance, Japanese Patent Application Laid-Open No. 6 (1994)-238070.

As described in this Japanese Patent Application Laid-Open No. 6 (1994)-238070, in a conventional inner cutter, an inner cutter main unit made of a metal is secured to a hub unit that is made of resin. FIG. 9 is a perspective view of an inner cutter 10 disclosed in Japanese Patent Application Laid-Open No. 6 (1994)-238070, FIG. 10 is a perspective view of an outer cutter 12 that works in combination with this inner cutter 10, and FIG. 11 is a side elevational view of the inner cutter with a part thereof omitted. Furthermore, FIG. 12 is a partial cross-sectional side view of the inner cutter, and FIG. 13 is a cross-sectional side view showing the inner and outer cutters 10 and 12 assembled.

As seen from FIG. 10, the outer cutter 12 is made of metal and in substantially a disk-shape. In other words, the shape of the inner cuter 12 is made so that the circumferential edge of a metal disk is bent to form a shallow, substantially dish-shaped or substantially inverted bowl-shaped entity, and in the upper surface of this outer cutter 12, numerous slits 14 that are hair introduction openings are opened in a radial pattern. In the upper surface of the outer cutter, a ring-shaped channel 16 is formed so as to cross the slits 14 in the vicinity of the middle portions thereof. As a result, as seen from FIG. 13, the inner surface of the outer cutter 12 has tracks 12A and 12B that are defined by this ring-shaped channel 16 to form two concentric circles that bound therebetween the channel 16. A structure such as this in which the outer cutter 12 has two tracks 12A and 12B is called a double track structure.

On the other hand, the inner cutter 10, as seen from FIG. 9, is comprised of a hub unit 18 which is made of a polyoxymethylene (POM) resin such as a product “Delrin” (registered trademark) made by DuPont, for example; and, as seen from FIG. 13, the lower part of this hub unit 18 is formed to have an inverted bowl portion 20 that opens downward. In this inverted bowl portion 20, an engagement hole 22 is provided, so that a rotary drive shaft (not shown in the drawing) is coupled to the engagement hole 22 of the hub unit 18 from below (from the main body side of the shaver). Furthermore, a column-shaped protruding portion 24 is formed in the center of the upper surface of the hub unit 18.

The reference numeral 26 (see FIG. 9) is an inner cutter main unit of the inner cutter 10, and it is fabricated by draw-molding and bending a metal sheet and forming into a substantially pinwheel-shaped entity. More specifically, this circular inner cutter main unit 26 has, as seen from FIG. 9, ten risers 30, which mutually separate and stand up from the outer circumference of a disk unit 28, and cutter units 32, which are formed on the risers 30 by being further bent into the outside in the radial direction of the inner cutter main unit along straight lines that pass through the center of the hub unit 18. The disk unit 28 is tightly secured to the upper surface of the inverted bowl portion 20 of the hub unit with a column-shaped protruding portion 24 of the hub unit 18 passing through the center of this disk unit 28. In other words, the disk unit 28 is secured to the hub unit 18 by soldering.

The upper part of each of the cutter units 32 of the inner cutter main unit 26 is separated into a two-pronged fork shape, thus forming a pair of cutter blades 34 and 34. These cutter blades 34 and 34 engage from below (from the inside) the two tracks 12A and 12B, respectively, of the outer cutter 12 as seen from FIG. 13. As a consequence, when the hub unit 18 and the inner cutter main unit 26 are rotated in the clockwise direction CL in FIGS. 9 and 11, as seen from above, by the rotary drive shaft (not shown), all of the cutter blades 34 and 34 are rotated while sliding against the inner bottom surfaces of the tracks 12A and 12B of the outer cutter 12 (FIG. 13). As a result, hair (whiskers, for example) which has entered into the slits 14 of the outer cutter 12 is cut by the rotating cutter blades 34 and 34.

The column-shaped protruding portion 24 of the hub unit 18, as seen from FIG. 13, engages a circular hole 40 formed in a cap 38 that is secured to the center of the outer cutter 12, from below, and prevents wobbling of the inner cutter 10.

The cutter blades 34 of the inner cutter 10 are, as seen from FIG. 11, inclined so that the upper ends thereof are displaced more in the direction of rotation CL than are the lower parts thereof. In other words, the upper ends of the cutter blades 34 are tilted forward in the direction of rotation CL. Furthermore, in the surface of each one of the cutter blades 34, or on the side of each one of the cutter blades 34 that faces backward to the direction of rotation (in the counter-rotation direction), a recess 36 is formed so that part of the recess 36 takes part of the upper end surface (the blade surface which slides against the outer cutter 12) of the cutter blade 34. These recesses (concavities) 36 prevent hair debris, grime and the like from adhering to the cutter blades 34, while also functioning to reduce the contact surface area between the cutter blades 34 and the outer cutter 12, thus reducing drive resistance (see the above-described Japanese Patent Application Laid-Open No. 6 (1994)-238070). The presence or absence of these concavities 36 is, however, irrelevant to the present invention.

The inner cutter 10 and the outer cutter 12 described above form a cutter unit, and three, for instance, of the cutter units are respectively positioned at apexes of an equilateral triangle with three inner cutters 10 rotationally driven by a single motor of the shaver. The inner cutter 10 and outer cutter 12 combination can be installed in a shaver in two units or in a single unit.

As seen from the above, with the conventional inner cutter 10, the entire inner cutter main unit 26 is fabricated by press-punching a metal sheet, and then forming bends of approximately 90° at the two locations A and B in FIGS. 11 and 12. Meanwhile, because the cutter blades 34 are inclined toward the direction of rotation of the inner cutter 10, it is necessary to use a metal sheet that is sufficiently great in thickness so as to obtain sufficient rigidity for the cutter blades 34, against the contact resistance with the tracks 12A and 12B of the outer cutter 12, in order to prevent vibration of the cutter blades 34 of the inner cutter 10. The reason for obtaining good rigidity is that due to the resistance acting on the upper surfaces of the cutter blades or on the blade tip ends, the contact pressure of the cutter blades increases, whereupon a so-called self-servo effect occurs. The above-described structure, in which the blade tip end constituting the point where such force acts precedes the support part that constitutes the fulcrum of swing of the cutter blade in the direction of rotation, is called a leading structure.

However, when a metal sheet having a large thickness is used in forming inner cutters, the workability of press-punch machining and bend machining and the like deteriorates. When workability deteriorates, variation in the inclination of the upper surfaces of the cutter blades 34 increases, and variation in the tightness between the upper surfaces of the cutter blades 34 and the tracks 12A and 12B becomes larger as well.

When there is variation in the tightness between the upper surfaces of the cutter blades 34 of the inner cutter and the tracks 12A and 12B of the outer cutter, it might be possible to elevate this tightness by increasing the force that presses the cutter blades 34 against the tracks 12A and 12B. By doing so, however, the sliding resistance increases, wear occurs more quickly in the cutter blades 34 and the tracks 12A and 12B and the like, resulting in such problems as poor durability and noise.

Another conceivable way to increase the rigidity of the cutter blades 34 is to broaden the lateral width of the cutter blades 34 (the “lateral width” being a width thereof in the radial direction relative to the rotary drive shaft). In this case, however, the problem is that hair debris, skin oil and the like readily adhere to the cutter blades 34, and cleaning of the inner cutter becomes difficult.

### BRIEF SUMMARY OF THE INVENTION

The present invention is made in view of such circumstances as described above.

It is a first object of the present invention to provide a rotary electric shaver in which the tightness between the cutter blades of the inner cuter and the tracks of the outer cutter is enhanced without making the force that presses the cutter blades against the tracks larger, the quality of shaving is enhanced, durability is high while preventing noise increase, and, in addition, the adherence of hair debris, oil and the like is greatly prevented, and cleaning of the shaver is easy.

It is a second object of the present invention to provide an inner cutter for use in such an electric shaver.

The first object is accomplished by a unique structure of the present invention for a rotary electric shaver that includes a substantially disk-shaped outer cutter having numerous hair introduction openings which open in the upper surface thereof and an inner cutter that rotates while sliding against the inside lower surface of the outer cutter; and in the present invention, the inner cutter comprises:
a circular hub unit that is coupled to a rotary drive shaft of the electric shaver; and
cutter blades that are secured at lower parts thereof to the hub unit, stand up from the lower parts, and slide at upper parts thereof against the inside lower surface of the outer cutter; and wherein
reduced cross-sectional portions, in which the dimension in the radial direction of the hub unit (or of the rotary drive shaft) is set to be smaller than the dimension in the radial direction of the blade tip ends of the cutter blades, are formed in the intermediate portions of the cutter blades.

The second object is accomplished by a unique structure of the present invention for inner cutters used in rotary electric shavers, and in the present invention, the inner cutter is comprised of:
a hub unit that is coupled to a rotary drive shaft of the electric shaver; and
cutter blades that are secured at lower parts thereof to the hub unit, stand up from the lower parts, and slide at upper parts thereof against the inside lower surface of the outer cutter; and
thin-material cross-sectional portions, in which dimension a thereof in the radial direction of the hub unit is smaller than dimension c in the radial direction of the blade tip ends of the cutter blades (a<c), are formed in the intermediate portions of the cutter blades.

The reduced cross-sectional portion formed in the intermediate portion of each one of the cutter blades readily bends in the radial direction of the hub unit (or of the rotary drive shaft), and therefore the upper part of the cutter blade of the inner cuter can make a pivotal swing in the radial direction. For this reason, the upper surface of the cutter blade can tilt easily left and right (in the radial direction) so as to fit tightly against the inside lower surface of the outer cutter. In other words, the tightness of the upper surface of the cutter blade of the inner cutter is high without increasing the force that presses the cutter blade against the inside lower surface (inner surface) of the outer cutter.

Accordingly, not only can the quality of the shave be enhanced, but also wear in the sliding parts of the cutter blades and the outer cutter decreases, and the durability of these parts are enhanced. Furthermore, noise associated with sliding motion of the inner cutter with respect to the outer cutter is reduced, and the reduced cross-sectional portions formed in the intermediate portions of the cutter blades smoothes the surrounding airflow, discouraging the adherence of hair debris, oil and the like to the cutter blades, making the cleaning of the inner cutter easy.

Furthermore, the reduced cross-sectional portions of the cutter blades have reduced surface areas in the direction of travel (direction of rotation) of the cutter blades, so that air resistance decreases; and it is, as a result, not necessary to make the contact pressure between the cutter blades of the inner cutter and the inner surface of the outer cutter larger (or the contact pressure can even be made smaller), and sliding resistance decreases. Accordingly, the driving force for the inner cutter can be small, the motor can be accordingly smaller in size, and also electric power consumption can be lowered.

In the present invention, the ratio a/b of the dimension (thickness) a in the radial direction of the reduced cross-sectional portions of the cutter blades and the dimension (width) b in the circumferential direction thereof can be set to be equal to or less than 0.5; and with this ratio, the reduced cross-sectional portions are sufficiently elastic in the radial direction, and it is possible for the upper parts of the cutter blades to even more easily pivotally swing in the radial direction. Furthermore, the airflow is even smoother, so that the benefit of the present invention is enhanced further.

The number of tracks in the outer cutter can be one (single-track); however, two (double-track) or more than two tracks can be provided concentrically. When the outer cutter has two or more tracks, needless to say, the inner cutter has the cutter blades in the corresponding or same number as the number of tracks.

In the present invention, the cutter blades can be formed so that the supporting parts in the lower parts thereof precede the blade tip ends in the upper ends thereof (that is, the edges on the rotating-direction side of the upper end surfaces) in the direction of rotation of the inner cutter. In this structure, the upper ends of the cutter blades are easily displaced, when the inner cutter is being rotated, in the reverse direction of the direction of rotation (i.e. in the counter-rotating direction) due to the resistance resulting from hair striking the blade tip ends, the sliding resistance against the tracks and the like. As a result, the rigidity of the cutter blades can be made smaller. For this reason, a thinner metal sheet can be used for making the inner cutter, the contact pressure of the cutter blades with respect to the outer cutter can be smaller, and the benefit of the present invention can be made even greater.

Furthermore, in the present invention, openings can be formed in the upper parts of the cutter blades so that the openings open in the circumferential direction (or in the direction of rotation) and open through the circumferential direction. With this structure, it becomes even easier for the air to pass through the cutter blades; and as a result, the benefit of the present invention further increases. In addition, the longer sides (surfaces in the circumferential direction) of the reduced cross-sectional portions can be made to be parallel to the direction of rotation (circumferential direction) of the cutter blades, and in addition, they can also be twisted slightly in a propeller blade shape. Depending on the direction of twist in the surfaces of the longer sides of the cutter blades, vibration in the radial direction of the cutter blades is suppressed since the air resistance resulting from the traveling cutter blade is added to the pressure on the inside or outside, in the radial direction, of the cutter blades. In particular, if the twisting is formed so that pressure is added in the inner radial direction (on the inside) on the cutter blades, balance can be effected with the centrifugal forces acting on the cutter blades, and excessive pivotal swing toward the outer radial direction (on the outside) of the cutter blades is prevented.

The present invention is not limited to a rotary electric shaver having an integral structure in which a plurality of cutter blades of an inner cutter is formed from a common metal sheet. For example, a plurality of cutter blades are divided and individually secured to a hub unit, or the cutter blades can be insert-molded.

### BRIEF DESCRIPTION OF THE SEVERAL VIEWS OF THE DRAWINGS

FIG. 1 is an external perspective view of a rotary electric shaver according to the first embodiment of the present invention;

FIG. 2 is a cross-sectional side view of an inner cutter and an outer cutter in the first embodiment of the present invention;

FIG. 3 is a perspective view of an inner cutter of the first embodiment;

FIG. 4 is an enlarged perspective view of the area P of FIG. 3;

FIG. 5A is a perspective view of the reduced cross-sectional portion of a cutter blade of an inner cutter, and FIG. 5B shows the cross-section taken along the lines Vb-Vb in FIG. 5A;

FIG. 6 is a cross-sectional side view of an inner cutter and an outer cutter in another embodiment of the present invention;

FIG. 7 is a partial cross-sectional side view of the inner cutter shown in FIG. 6;

FIG. 8 is a perspective view of a cutter blade of an inner cutter of still another embodiment of the present invention;

FIG. 9 is a perspective view of a conventional inner cutter of a rotary electric shaver;

FIG. 10 is a perspective view of a conventional outer cutter used in a rotary electric shaver;

FIG. 11 shows a part of the inner cutter of FIG. 9;

FIG. 12 is a cross-sectional view of a part of the same inner cutter; and

FIG. 13 is a cross-sectional view of the inner cutter and the outer cutter in the conventional electric shaver.

### DETAILED DESCRIPTION OF THE INVENTION

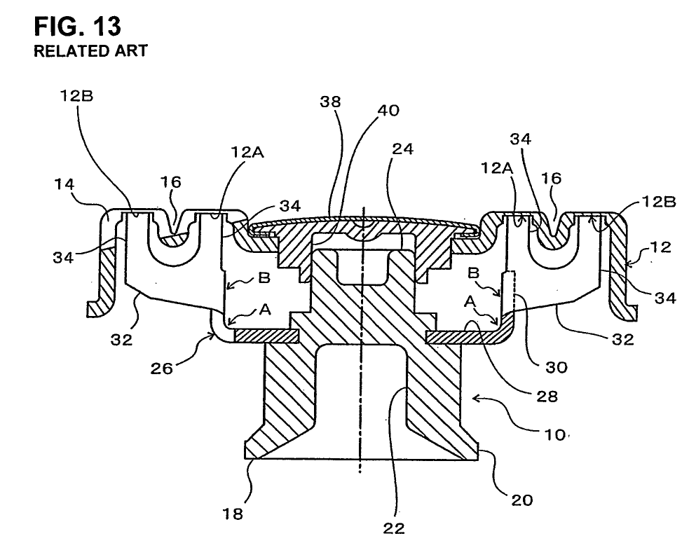

In the present invention, the inner cutter 56 is used in combination with an outer cutter 12 instead of the inner cutter 10 shown in FIG. 13. For this reason, the same reference numerals are used for parts that are identical to those in FIG. 13, and the descriptions thereof are not repeated hereinafter.

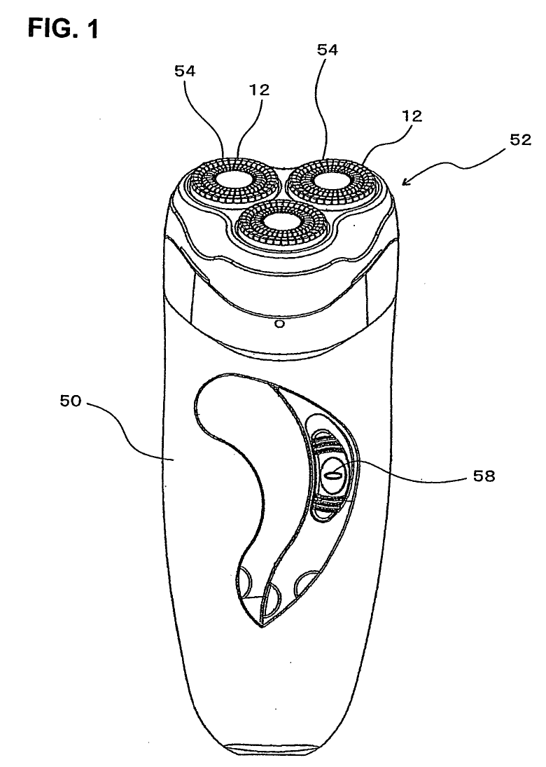

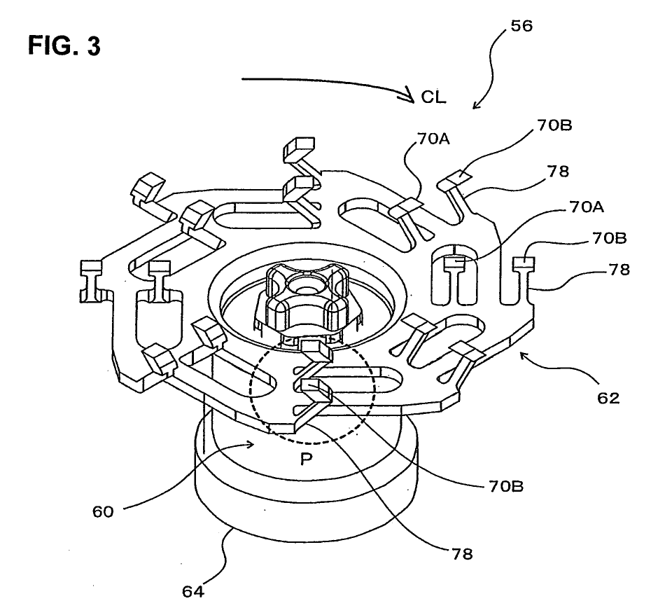

In FIG. 1, the reference numeral 50 is a shaver main body, and 52 refers to a head unit. The head unit 52 is detachably attached to the upper part of the shaver main body 50. In the head unit 52, three sets of cutter units 54 are provided. Each cutter unit 54 is comprised of an inner cutter 56 (see FIG. 3) and a disk-shaped outer cutter 12, and the outer cutters 12 of the three cutter units 54 are provided on a substantially triangular upper surface of the head unit 52 so that they can sink in.

The inner cutters 56 are rotationally driven by an electric motor (not shown) housed inside the shaver main body 50 and slide against the inside lower surfaces (inner surfaces) of the outer cutters 12 from below. More specifically, the rotation of the motor is transmitted through a speed reduction device (not shown) to three rotary drive shafts (not shown), and as a result, with the upper ends of these rotary drive shafts coupled to the inner cutters 56 from below, the inner cutters 56 are rotated. To the three rotary drive shafts, moreover, an upward elastic returning tendency is imparted (by, for instance, coil springs), and as a result the inner cutters 56 is provided with an upward returning force that is imparted thereto (in a direction whereby they are pressed against the outer cutters 12) by these rotary drive shafts. A battery (not shown) is installed inside the shaver main body 50, and the motor is switched on and off by on-off operations of a switch 58.

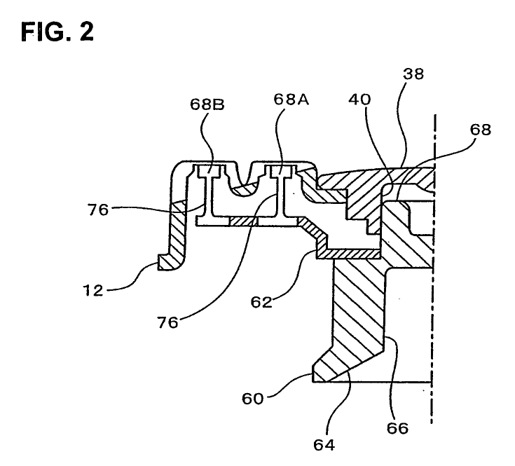

The outer cutters 12, as described above, are of the same structure as the one shown in FIG. 13. On the other hand, each one of the inner cutters 56 is comprised of a circular (or circular cylindrical) hub unit 60 and a ring-shaped inner cutter main unit 62 provided (fixed) to this hub unit 60. The lower part of the hub unit 60 has, as seen from FIG. 2, an inverted bowl-shaped portion 64, and an engagement hole 66 is formed therein sodas to open downward. A column-shaped protruding portion 68 is formed on the center of the upper portion of the hub unit 60. The protruding portion 68 engages a circular hole 40 formed in the cap 38 of the outer cutter 12.

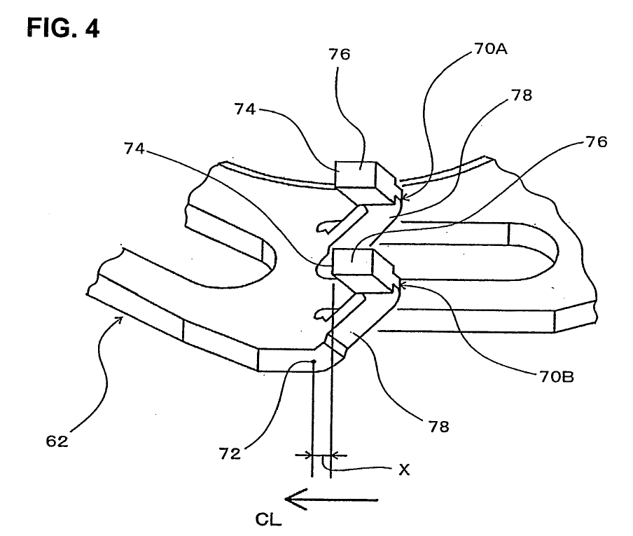

The inner cutter main unit 62 is obtained by draw-molding and bending a metal sheet. The inner cutter main unit 62 is formed with eight sets of cutter blades 70 (70A and 70B) that respectively slide against the two concentric tracks 12A and 12B. The cutter blades 70A and 70B are aligned in the radial direction of the circular hub unit 60 (or of the rotary drive shaft) and are raised up in its circumferential direction. Here, the cutter blades 70 are made, as seen from FIGS. 3 to 5, so that supporting parts 72, which are at the lower portions thereof, precede blade tip ends 74, which are at the upper ends thereof, in the direction of rotation CL of the inner cutter. More specifically, as shown in FIG. 4, the cutter blades 70 (70A and 70B) are bent in substantially>shapes as seen from the outside in the radial direction (or as seen from the side), so that the upper end surfaces 76 slide against the tracks 12A and 12B of the outer cuter, and the blade tip ends 74 thereof (or the leading edges) are displaced by a distance x from the supporting parts 72 in the counter-rotating direction.

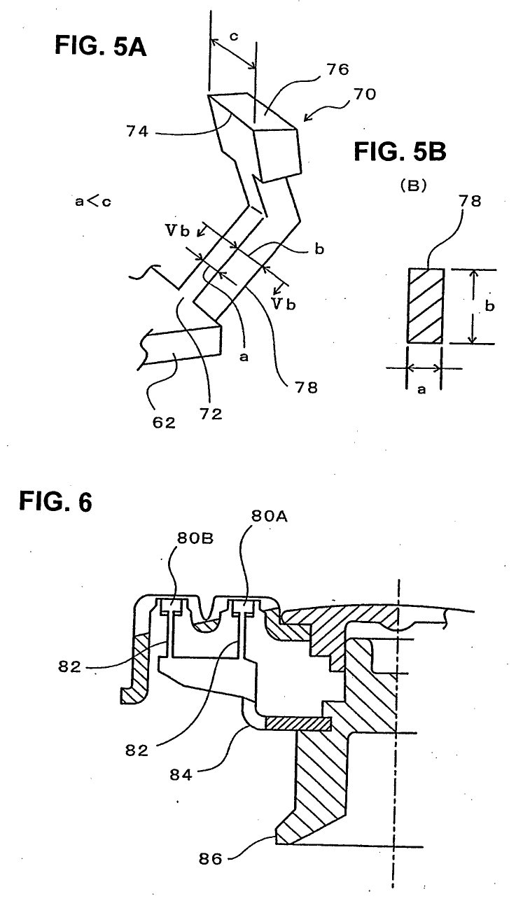

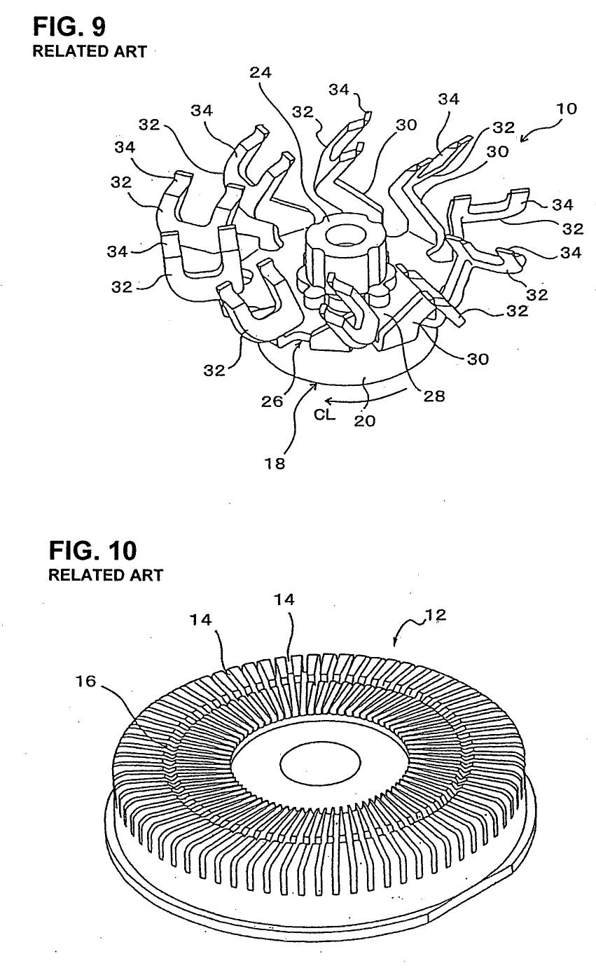

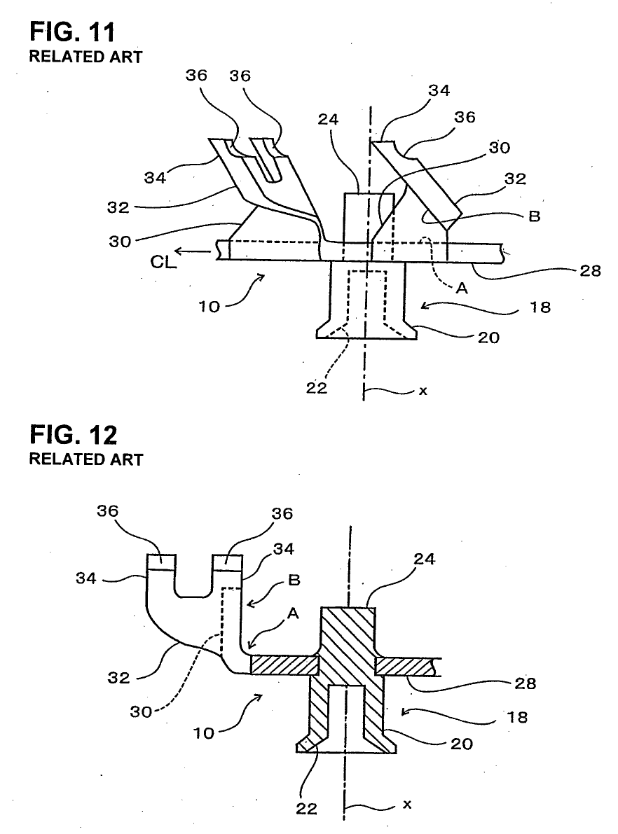

With the structure described above, when the blade tip ends 74 strike the hair for cutting, the cutter blades 70 will topple over in the counter-rotating direction about fulcrums that are in the vicinity of the supporting parts 72 thereof, and the self-servo effect present in the conventional structure (leading structure) shown in FIG. 9 to 13 described above does not operate. The reason for this is that in the structure of the present invention (that takes a leading edge trailing structure) the blade tip ends 74 are positioned more in the counter-rotating direction (behind) than the supporting parts 72. As a result, the rigidity of the cutter blades 70 can be small; and by making the thickness of the inner cutter main units 62 smaller or, as seen from FIGS. 5A and 5B, by setting the dimension b in the direction of the rotation of reduced cross-sectional portions 78 smaller, the blade tip ends 74 can readily swing forward and backward (or in the rotating and counter-rotating directions).

Furthermore, the intermediate portions of the cutter blades 70 are machined by press-punching (or by being cut out) from both sides thereof in the radial direction so as to make reduced cross-sectional portions 78 in which the thickness is smaller in the radial direction. More specifically, as seen from FIG. 5A, in the reduced cross-sectional portion 78, the dimension (thickness) a in the radial direction is smaller than the dimension (width) c in the radial direction of the blade tip end 74 (a<c), with a being made sufficiently smaller such that a/c<0.7 (a/c is less than or equal to 0.7), for example. With this structure, the upper part of the cutter blade 70 can easily swing (pivotally swing) in the radial direction (of the circular hub unit 60 or of the ring-shaped inner cutter main unit 62), and air resistance during high-speed rotation of the inner cutter can decrease so as to be smaller, increasing the advantages of the present invention in great deal. Moreover, with the use of a thinner metal plate for fabricating the cutter main unit 62, the advantages of the present invention are made greater.

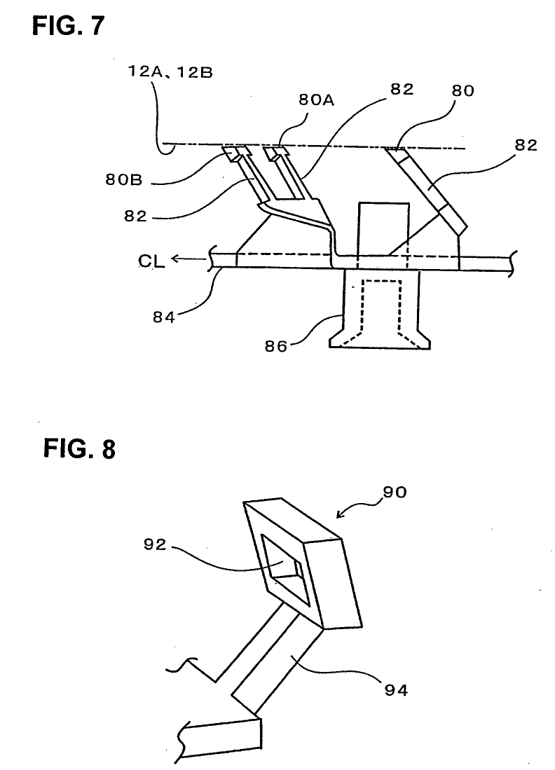

FIG. 6, a cross-sectional side view, and FIG. 7 show the inner and outer cutters assembled in another embodiment of the present invention.

The cutter blades 80 (80A and 80B) of the structure of FIG. 6 are the same as the cutter blades 34 of the inner cutters 10 of the conventional structure shown in FIGS. 9 to 13 described above but have reduced cross-sectional portions 82. More specifically, in the inner cutter main unit 84, the intermediate portions of the cutter blades 80 are bent upward from the metal sheet and made thinner in the radial direction, and this inner cutter main unit 84 is provided on a hub unit 86. The outer cutter for the inner cutter of FIGS. 6 and 7 is the same as that of FIG. 13 in structure, and the same reference numerals in FIG. 13 are applied to those parts of FIGS. 6 and 7; and therefore, the descriptions thereof are not repeated here.

FIG. 8 shows, in a perspective view, still another embodiment of the cutter blade of an inner cutter of the present invention.

The cutter blade 90 in FIG. 8 is provided with an opening 92 that is formed in the upper part of the cutter blade 90 so that the opening 90 faces the circumferential direction of the inner cutter and passes through in the circumferential direction. The intermediate portion below the opening 92 is a reduced cross-sectional portion 94 which is machined so as to be thinner in the radial direction as in the structure shown in FIGS. 5A and 5B.

In the structure shown in FIG. 8, air will flow so as to pass through the opening 92 when the inner cutter 90 is rotated. As a consequence, the surface area facing in the direction of rotation of the inner cutter, inclusive of the reduced cross-sectional portion 94, is reduced even further, and air resistance thus decreases further, and smooth airflow is promoted. As a result, the adherence of hair debris to the cutter blades is less likely, and cleaning of the inner cutter is easy.

In the present invention, the reduced cross-sectional portions formed in the intermediate portions of the cutter blades of the inner cutter can be slightly twisted in a propeller shape.

1. A rotary electric shaver comprising a substantially disk-shaped outer cutter having hair introduction openings which open in an upper surface thereof and an inner cutter that rotates while sliding against an inside lower surface of said outer cutter; wherein said inner cutter comprises:
a circular hub unit that is coupled to a rotary drive shaft of said electric shaver; and
cutter blades that are secured at lower parts thereof to said hub unit, stand up from the lower parts, and slide at upper parts thereof against the inside lower surface of said outer cutter; and wherein
each of said cutter blades is provided in an intermediate portion thereof with a reduced cross-sectional portion, in which a dimension thereof in a radial direction of said circular hub unit is smaller than a dimension in a radial direction of a blade tip end of each of said cutter blades.

2. The rotary electric shaver according to claim 1, wherein a ratio a/c of dimension a in a radial direction of the intermediate portions of the cutter blades and dimension c in the radial direction of the blade tip ends is less than or equal to 0.7.

3. The rotary electric shaver according to claim 1, wherein said outer cutter is formed with a plurality of concentric tracks, and said inner cutter is provided with a plurality of said cutter blades which slide against the concentric tracks from below.

4. The rotary electric shaver according to claim 1, wherein supporting parts in the lower parts of the cutter blades are formed so that said supporting parts precede the blade tip ends at the upper ends of the cutter blades in a direction of rotation of the inner cutter.

5. The rotary electric shaver according to claim 1, wherein the cutter blades are provided with openings in upper parts thereof, and said openings are formed so as to open toward a circumferential direction of the inner cutter and pass through the upper parts in the circumferential direction.

6. The rotary electric shaver according to claim 1, wherein the reduced cross-sectional portions formed in the intermediate portions are twisted in a propeller shape.

7. An inner cutter for a rotary electric shaver, said inner cutter comprising:
a circular hub unit that is coupled to a rotary drive shaft of said electric shaver; and
cutter blades that are secured at lower parts thereof to said hub unit, stand up from lower parts thereof, and slide at upper parts thereof against an inside lower surface of said outer cutter; and wherein
each of said cutter blades is provided in an intermediate portion thereof with a reduced cross-sectional portion, in which a dimension thereof in a radial direction of said circular hub unit is smaller than a dimension in a radial direction of a blade tip end of each of said cutter blades.
